(19) United States
(12) Patent Application Publication
(10) Pub. No.: US 2023/0049303 A1
(43) Pub. Date: Feb. 16, 2023

(54) BINDER COMPOSITION FOR BOARD COATING SLIPS

(71) Applicant: BASF SE, Ludwigshafen am Rhein (DE)

(72) Inventors: Christian JEHN-RENDU, Ludwigshafen am Rhein (DE); Silke BOERNER, Ludwigshafen am Rhein (DE); Steffen GEIGER, Ludwigshafen am Rhein (DE)

(21) Appl. No.: 17/881,652

(22) Filed: Aug. 5, 2022

(30) Foreign Application Priority Data
Aug. 6, 2021 (EP) 21190066.7

(51) Int. Cl. C09D 5/02; C09D 125/14; C09D 7/61

(52) U.S. Cl. CPC C09D 5/022; C09D 125/14; C09D 7/61

(57) ABSTRACT

The invention relates to a coating slip comprising
(i) an aqueous dispersion of one or more vinyl acetate polymers, obtainable by free-radically initiated emulsion polymerization of
   77% to 99% by weight of vinyl acetate,
   1% to 13% by weight of ethylene and
   0% to 10% by weight of one or more monoethylenically unsaturated monomers that are neither vinyl acetate nor ethylene,
   where the amounts of the monomers add up to 100% by weight,
(ii) an aqueous dispersion of one or more styrene copolymers, obtainable by free-radically initiated emulsion polymerization of a monomer composition comprising
   35% to 70% by weight of styrene,
   20% to 60% by weight of one or more esters of acrylic and/or methacrylic acid with alkanols having 1 to 12 carbon atoms, or of one or more conjugated aliphatic dienes,
   1% to 10% by weight of one or more monomers comprising acid groups,
   where the amounts of the monomers add up to 100% by weight,
(iii) inorganic pigments and
(iv) optionally further auxiliaries,
where the total amount of emulsion polymers (i) and (ii) is 10 to 30 parts by weight based on 100 parts by weight of inorganic pigment (iii) and
where the weight ratio of the styrene copolymer to the vinyl acetate polymer is 77:23 to 93:7, and to a method of producing the coating slip, to the use thereof for coating board, to a method of coating board with the coating slip and to the board coated thereby.

The invention relates to a coating slip comprising an aqueous dispersion of a vinyl acetate polymer and a dispersion of a styrene copolymer.

One of the most important tasks of board is its function as packaging material, which is printed in a multitude of cases. However, a fibrous substrate such as board has a relatively rough surface compared to paper. In order to improve its printability, but also its quality with regard to smoothness and gloss, board is coated with coating slips, as is paper as well. Aqueous paper coating slips essentially comprise synthetic binders, pigment, further auxiliaries and water. Binders that have become established for paper coating slips are especially copolymers based on styrene and butadiene and based on styrene and acrylic esters.

WO 2012/012231 teaches vinyl acetate/ethylene polymers with crosslinking monomers, which, as binder in paper coating slips, lead to good strength and reduced picking on printing. The ethylene content of these polymers is 12 or more parts by weight based on 100 parts by weight of monomer.

DE 10 2010 063 470 teaches, as synthetic binder for paper coating slips, a combination of a styrene-butadiene copolymer or a styrene-acrylic ester copolymer, in each case with a vinyl acetate-ethylene polymer stabilized with polyvinyl alcohol, for improvement of the whiteness and coat porosity of coated print substrates. The mixtures used here have a ratio of vinyl acetate/ethylene polymer to styrene copolymer of 25:75.

US 2015/0125711 describes binder compositions for paper coating slips composed of functionalized vinyl acetate/ethylene polymers and styrene/butadiene polymers, and also mixtures of vinyl acetate/ethylene polymers and styrene/acrylate polymers. Some vinyl acetate/ethylene polymers have been carboxyl-functionalized and have an ethylene content based on the polymer of 14% by weight or more. Papers coated with such coating slips have good strength and hence reduced picking. The proportion by weight of the functionalized vinyl acetate/ethylene polymers in the total binder is 20% to 80%.

What is common to all these documents is that paper is being coated. However, none of these documents addresses the specific problems in the coating of multilayer board.

Board generally has multiple layers, i.e. consists of multiple layers of paper of different thickness and to some degree made of different material, which are pressed together (couched) without use of adhesive. Coated board is used as packaging material for a multitude of products. In the course of production of packaging from board, the fold lines are first defined in order to avoid tearing of the board on folding. It is often the case that fracture of a layer is observed on folding. This separation of the individual board layers, often breakup of a relatively soft middle board layer, is also referred to as delamination and also often occurs during the printing operation. Here, the viscous printing ink on the print roll causes a tensile force in z direction of the paper surface, which likewise causes breakup of a board layer, called delamination. The effect of this tensile force in z direction in the printing operation is also known from the coating of paper, where the damage in this case occurs directly on the surface since parts of the paper coat become detached from the raw paper, which is called picking. While picking relates to pigments on the paper surface, the damage to the multilayer board occurs in the fiber layer and is manifested in formation of creases.

It was an object of the present invention to find a coating slip that reduces delamination in the printing of multilayer board. In addition, board coated thereby should also have good strength, i.e. the slip should not have any picking.

The object was achieved in accordance with the invention by a coating slip comprising
(i) an aqueous dispersion of one or more vinyl acetate polymers, obtainable by free-radically initiated emulsion polymerization of
   77% to 99% by weight of vinyl acetate,
   1% to 13% by weight of ethylene and
   0% to 10% by weight of one or more monoethylenically unsaturated monomers that are neither vinyl acetate nor ethylene,
   where the amounts of the monomers add up to 100% by weight,
(ii) an aqueous dispersion of one or more styrene copolymers, obtainable by free-radically initiated emulsion polymerization of a monomer composition comprising
   35% to 70% by weight of styrene,
   20% to 60% by weight of one or more esters of acrylic and/or methacrylic acid with alkanols having 1 to 12 carbon atoms, or of one or more conjugated aliphatic dienes,
   1% to 10% by weight of one or more monomers comprising acid groups, where the amounts of the monomers add up to 100% by weight,
(iii) inorganic pigments and
(iv) optionally further auxiliaries,

where the total amount of emulsion polymers (i) and (ii) is 10 to 30 parts by weight based on 100 parts by weight of inorganic pigment (iii) and where the weight ratio of the styrene copolymer to the vinyl acetate polymer is 77:23 to 93:7, preferably 90:10.

The invention also relates to a method of producing the coating slip, to the use thereof for coating board, to a method of coating board with the coating slip and to the board coated thereby.

The expression “(meth)acryl-” and similar expressions are used hereinafter in each case as abbreviated notation for “acryl- and methacryl-”.

The term “board” hereinafter is understood to mean an article consisting of fibrous material that has a mass per unit area, also loosely referred to as “basis weight”, in the range from 150 to 600 g/m², determined to DIN EN ISO 536.

The polymer dispersions to be used in accordance with the invention comprise dispersions of polymers in aqueous medium. This may be, for example, fully demineralized water or else mixtures of water and a solvent miscible therewith, such as methanol, ethanol or tetrahydrofuran. Preference is given to using no organic solvents. The solids contents of the dispersions are preferably from 15% to 75% by weight, more preferably from 40% to 60% by weight, especially greater than 50% by weight. The solids content can be effected, for example, by appropriate adjustment of the amount of water used in the emulsion polymerization and/or the amounts of monomer. The pH of the polymer dispersion is preferably adjusted to a pH greater than 3.5, more particularly to a pH of between 4.5 and 9.

According to the invention, the coating slip comprises one or more vinyl acetate polymers (i) obtainable by free-radically initiated emulsion polymerization from
77% to 99% by weight of vinyl acetate,
1% to 13% by weight, preferably 5% to 13% by weight, of ethylene, and
0% to 10% by weight of at least one monoethylenically unsaturated monomer that is neither vinyl acetate nor ethylene,

where the amounts of the monomers add up to 100% by weight.

The aqueous vinyl acetate polymers used in accordance with the invention have an ethylene content of 1% to 13% by weight based on the polymer. If further monoethylenically unsaturated monomers are used as well as vinyl acetate and ethylene, the polymer advantageously has a vinyl acetate content of 85% by weight.

Further useful monoethylenically unsaturated monomers include
vinyl esters of straight-chain or branched carboxylic acids having 3-18 carbon atoms, especially vinyl esters of an alpha-branched carboxylic acid having 9 to 11 carbon atoms,
acrylic, methacrylic, maleic or fumaric esters of aliphatic alcohols having 1-18 carbon atoms,
vinyl chloride,
isobutylene or higher α-olefins having 4 to 12 carbon atoms

and mixtures thereof.

Apart from the combination of vinyl acetate and ethylene, suitable monomer combinations are, for example, vinyl acetate/vinyl pivalate/ethylene, vinyl acetate/vinyl 2-ethylhexanoate/ethylene, vinyl acetate/methyl methacrylate/ethylene and vinyl acetate/vinyl chloride/ethylene, from the group of the so-called terpolymers.

Aqueous dispersions based on vinyl acetate and ethylene are commonly known and are described, for example, in DE 102010063470, with explicit reference to the disclosure thereof.

Preference is given to vinyl acetate polymers having a glass transition temperature T_{g} in the range from 10 to 30° C., measured to DIN EN ISO 11357-2 (2013-09). Advantageously, the glass transition temperature of the vinyl acetate polymers is in the range from 15 to 25° C., especially in the range from 15 to 20° C.

A further important point is that, according to Fox (T. G. Fox, Bull. Am. Phys. Soc. 1956 [Ser. II] 1, page 123 and according to Ullmann's Encyclopädie der technischen Chemie [Ullmann's Encyclopedia of Industrial Chemistry], vol. 19, page 18, 4th edition, Verlag Chemie, Weinheim, 1980), the glass transition temperature of at most lightly crosslinked copolymers can be estimated in a good approximation by the following equation:

1/Tg=x₁/Tg¹+x₂/Tg²+ . . . xₙ/Tgⁿ,

where x₁, x₂, . . . xₙ are the mass fractions of the monomers 1, 2, . . . n and Tg¹, Tg², . . . Tgⁿ are the glass transition temperatures in degrees kelvin of the homopolymers synthesized from in each case only one of the monomers 1, 2, . . . n. The glass transition temperatures of these homopolymers of most ethylenically unsaturated monomers are known (or can be ascertained experimentally in a simple manner known per se) and are listed, for example, in J. Brandrup, E. H. Immergut, Polymer Handbook 1st Ed. J. Wiley, New York, 1966, 2nd Ed. J. Wiley, New York, 1975 and 3rd Ed. J. Wiley, New York, 1989, and in Ullmann's Encyclopedia of Industrial Chemistry, page 169, Verlag Chemie, Weinheim, 1992.

In a preferred embodiment, a vinyl acetate polymer is chosen that is obtainable by free-radically initiated emulsion polymerization of
82% to 98% by weight of vinyl acetate, 1% to 13% by weight of ethylene and
1% to 5% by weight of one or more monoethylenically unsaturated monomers selected from vinyl esters of α-branched monocarboxylic acids having 9 to 11 carbon atoms, vinyl laurate, (meth)acrylic esters of unbranched or branched alcohols having 1 to 15 carbon atoms that also comprise 1 to 40% by weight of ethylene,

where the amounts of the monomers add up to 100% by weight.

In a likewise preferred embodiment, the vinyl acetate polymers are obtainable by free-radically initiated emulsion polymerization of a monomer composition consisting of 87% to 95% by weight of vinyl acetate and 5% to 13% by weight of ethylene, where the amounts of the monomers add up to 100% by weight.

The polymers are prepared in a known manner, for example, by emulsion polymerization methods in the presence of emulsifiers or preferably of protective colloids, preferably by the emulsion polymerization method as described hereinafter in the context of polymers (ii). The polymerization temperature for the polymers (i) is generally 20° C. to 100° C., preferably 60° C. to 90° C. In the copolymerization of gaseous comonomers, such as ethylene, preference is given to working under pressure, generally between 5 bar and 100 bar.

Protective colloids commonly used for stabilization of the polymerization mixture are likewise listed hereinafter in the context of polymers (ii).

The thus obtainable aqueous dispersions of the polymers (i) have a solids content of preferably 30% to 75% by weight, more preferably 50% to 60% by weight.

The styrene copolymers used in accordance with the invention are likewise used in the form of an aqueous dispersion. They are obtainable by free-radical emulsion polymerization of a monomer composition comprising 35% to 70% by weight of styrene, preferably 40% to 65% by weight, more preferably 40% to 59% by weight, of styrene and 20% to 60% by weight, preferably 30% to 59% by weight, of esters of acrylic acid and/or methacrylic acid with alkanols having 1 to 12 carbon atoms, or of a monomer composition comprising 35% to 70% by weight of styrene, preferably 45% to 70% by weight, more preferably 50% to 65% by weight, of styrene and 20% to 60% by weight, preferably 25% to 50% by weight, of a conjugated aliphatic diene, based in each case on 100% by weight of total monomer.

Styrene in combination with the esters of acrylic acid and/or methacrylic acid are the main monomers of what are called “styrene acrylates”. Styrene in combination with a conjugated aliphatic diene are the main monomers of the styrene/diene copolymers or, in the case of butadiene, of the styrene/butadiene copolymers. The coating slip of the invention comprises dispersions of styrene-acrylate copolymers or styrene/diene copolymers or mixtures thereof.

Suitable C₁-C₁₂-alkyl (meth)acrylates are, for example, alkyl (meth)acrylates having a C₁-C₁₂-alkyl radical, such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, sec-butyl acrylate, sec-butyl methacrylate, tert-butyl acrylate, tert-butyl methacrylate, pentyl acrylate, pentyl methacrylate,

2-ethylhexyl acrylate, 2-ethylhexyl methacrylate. In particular, mixtures of the (meth)acrylic acid alkyl esters are also suitable. Preference is given to n-butyl acrylate.

Suitable conjugated aliphatic dienes by way of example are butadiene-1,3, isoprene, pentadiene-1,3, dimethylbutadiene-1,3 and cyclopentadiene. From this group of monomers, preference is given to using butadiene-1,3 and/or isoprene, especially butadiene.

As well as the main monomers, the styrene copolymer comprises copolymerized monomers having acid groups, such as carboxylic acid, sulfonic acid or phosphoric acid groups. Monomers comprising acid groups are ethylenically unsaturated carboxylic acids, ethylenically unsaturated sulfonic acids and vinylphosphonic acid, and salts of these acids. The ethylenically unsaturated carboxylic acids used are preferably α,β-monoethylenically unsaturated mono- and dicarboxylic acids having 3 to 6 carbon atoms in the molecule. Examples of these are acrylic acid, methacrylic acid, itaconic acid, maleic acid, fumaric acid, crotonic acid, vinylacetic acid and vinyllactic acid. Examples of suitable ethylenically unsaturated sulfonic acids include vinylsulfonic acid, styrenesulfonic acid, acrylamidomethylpropanesulfonic acid, sulfopropyl acrylate and sulfopropyl methacrylate. Particular preference is given to acrylic acid and methacrylic acid, especially acrylic acid. The monomers comprising acid groups may be used in the polymerization in the form of the free acids or else in a form partially or completely neutralized by suitable bases. Preference is given to using sodium hydroxide solution, potassium hydroxide solution or ammonia as neutralizing agent.

According to the invention, the content of monomers comprising acid groups in the emulsion polymer is 1% to 10% by weight, preferably 1% to 8% by weight, especially 2% to 6% by weight.

In a likewise preferred embodiment, the monomer composition of the styrene copolymer consists of
40% to 59% by weight of styrene,
40% to 59% by weight of one or more esters of acrylic and/or methacrylic acid with alkanols having 1 to 12 carbon atoms,
1% to 10% by weight of one or more monomers comprising acid groups and
0% to 9% by weight of one or more other monoethylenically unsaturated monomers,

where the amounts of the monomers add up to 100% by weight.

Useful other monomers of this kind include monoethylenically unsaturated compounds that are neither styrene nor esters of acrylic acid and/or methacrylic acid with alkanols having 1 to 12 carbon atoms nor monomers comprising acid groups. Examples of these are ethylenically unsaturated carboxamides such as, in particular, acrylamide and methacrylamide, ethylenically unsaturated carbonitriles such as, in particular, acrylonitrile and methacrylonitrile, vinyl esters of saturated C₁ to C₁₈ carboxylic acids, preferably vinyl acetate, allyl esters of saturated carboxylic acids, vinyl ethers, vinyl ketones, dialkyl esters of ethylenically unsaturated dicarboxylic acids, N-vinylpyrrolidone, N-vinylpyrrolidine, N-vinylformamide, N,N-dialkylaminoalkylacrylamides, N,N-dialkylaminoalkylmethacrylamides, N,N-dialkylaminoalkyl acrylates, N,N-dialkylaminoalkyl methacrylates, vinyl chloride and vinylidene chloride. This group of monomers is optionally used for modification of the polymers.

Preferred other monomers are monomers comprising hydroxyl groups, especially C₁-C₁₀-hydroxyalkyl (meth)acrylates, and amides of unsaturated carboxylic acids, such as (meth)acrylamide.

In a preferred embodiment, the monomer composition of the styrene copolymer does not comprise any other monomer.

Preference is given to dispersions of one or more styrene copolymers comprising, preferably consisting of,
40% to 59% by weight of styrene,
40% to 59% by weight of one or more esters of acrylic and/or methacrylic acid with alkanols having 1 to 12 carbon atoms, preferably n-butyl acrylate, and
1% to 10% by weight of a monomer comprising acid groups,

where the amounts of the monomers add up to 100% by weight, in copolymerized form.

Such styrene copolymers are common knowledge, and they and their preparation alike are described, for example, in WO 2009/047233.

In emulsion polymerization, in general, ionic and/or nonionic emulsifiers and/or protective colloids or stabilizers are used as interface-active compounds in order to assist the dispersion of the monomers in the aqueous medium. Protective colloids are polymeric compounds which upon solvation bind large quantities of water and are capable of stabilizing dispersions of water-insoluble polymers. In contrast to emulsifiers, they generally do not lower the interfacial surface tension between polymer particles and water. An extensive description of suitable protective colloids can be found in Houben-Weyl, Methoden der organischen Chemie [Methods of Organic Chemistry], volume XIV/1, Makromolekulare Stoffe [Macromolecular Materials], Georg-Thieme-Verlag, Stuttgart, 1961, pages 411 to 420. If emulsifiers and/or protective colloids are additionally used as auxiliaries for dispersing the monomers, the amounts thereof used are, for example, 0.1% to 5% by weight based on the monomers. The interface-active substance is typically used in amounts of 0.1% to 10% by weight, based on the monomers to be polymerized.

The emulsion polymerization is generally effected at 30° C. to 130° C., preferably at 50° C. to 90° C. The polymerization medium may consist either solely of water or of mixtures of water and liquids miscible therein such as methanol. Preference is given to using solely water. The emulsion polymerization may be carried out either as a batch process or in the form of a feed method, including the staged and gradient mode of operation. Preference is given to the feed method, in which an initial charge of a portion of the polymerization batch is heated to the polymerization temperature and incipiently polymerized, then the remainder of the polymerization batch is fed in continuously or else in stages, typically via a plurality of spatially separate feeds, one or more of which comprise the monomers in pure form or in emulsified form.

In the emulsion polymerization, it is possible to use the customary and known auxiliaries, for example water-soluble initiators and chain transfer agents.

In a preferred embodiment, preference is given to styrene copolymer, especially styrene-acrylate polymers obtainable by free-radically initiated emulsion polymerization in the presence of 10% to 80% by weight, based on total monomers of the styrene copolymer, of a degraded starch.

Styrene-acrylate polymers that have been prepared in the presence of a degraded starch are described, for example, in EP 2580257, with explicit reference to the teaching thereof.

Styrene/diene polymers, especially styrene/butadiene polymers, that have been prepared in the presence of a degraded starch are described, for example, in EP 2197925, with explicit reference to the teaching thereof.

“Degraded starch” is understood by the person skilled in the art to mean a starch having a polymer chain that has been degraded with cleavage of glycosidic bonds. It therefore comprises fewer repeat units than the polymer chain of the parent native starch. The degradation of the starch is manifested, for example, in its intrinsic viscosity.

Suitable original starches for producing the degraded starches to be used with preference are all native starches such as starches from corn, wheat, oats, barley, rice, millet, potatoes, peas, tapioca, sorghum or sago. Original starches of interest are also those natural starches having a high amylopectin content such as waxy corn starch and waxy potato starch. The amylopectin content of these starches is above 90%, usually 95 to 100%.

The starches can be degraded enzymatically, oxidatively or hydrolytically by the action of acids or bases. The degradation of starch is generally known and is described in EP 2197925, for example. Degraded starches are commercially available. A degraded starch can be introduced for the polymerization or one can be prepared in situ and the polymerization then conducted in the presence thereof.

Particular preference is given to degraded native starches, in particular native starches degraded to maltodextrin.

Preference is given to degraded starches having an intrinsic viscosity ηi of ≤0.07 dl/g or ≤0.05 dl/g. The intrinsic viscosity ηi of the degraded starches is preferably in the range from 0.02 to 0.06 dl/g. The intrinsic viscosity ηi is determined in accordance with DIN EN 1628 at a temperature of 23° C.

The dispersions are generally monomodal dispersions. In a preferred embodiment, a bimodal dispersion is used.

The coating slip of the invention comprises the aqueous dispersion of one or more vinyl acetate polymers (i) and the aqueous dispersion of one or more styrene copolymers (ii), preferably styrene-acrylate polymers, and inorganic pigment (iii), where the total amount of the emulsion polymers (i) and (ii) is 10 to 30 parts by weight, based on 100 parts by weight of inorganic pigment (iii), where the weight ratio of the styrene copolymer to the vinyl acetate polymer is 77:23 to 93:7, preferably 77:23 to 90:10, especially 80:20 to 90:10, in particular 83:17 to 88:12. The dispersions of the vinyl acetate polymer and of the styrene copolymer are preferably the total amount of binder.

Particular preference is given to a combination of a vinyl acetate polymer obtainable by free-radically initiated emulsion polymerization of
90% to 99% by weight of vinyl acetate,
1% to 10% by weight of ethylene

and a styrene copolymer obtainable by free-radically initiated emulsion polymerization of a monomer composition consisting of
40% to 59% by weight of styrene,
40% to 59% by weight of one or more esters of acrylic and/or methacrylic acid with alkanols having 1 to 12 carbon atoms, preferably n-butyl acrylate, and
1% to 10% by weight of acrylic acid,

where the amounts of the monomers in each case add up to 100% by weight.

The coating slip of the invention comprises inorganic pigments in an amount of preferably at least 80% by weight, for example 80% to 95% by weight or 80% to 90% by weight, based on the total solids content.

White pigments are especially suitable. Examples of suitable pigments are metal salt pigments such as for example calcium sulfate, calcium aluminate sulfate, barium sulfate, magnesium carbonate and calcium carbonate, among which carbonate pigments and especially calcium carbonate are preferred. The calcium carbonate can be ground calcium carbonate (GCC, natural ground calcium carbonate), precipitated calcium carbonate (PCC), lime or chalk. Suitable calcium carbonate pigments are available, for example, as Covercarb® 60, Hydrocarb® 60 or Hydrocarb® 90. Further suitable pigments are for example silicas, aluminum oxides, aluminum hydroxide, silicates, titanium dioxide, zinc oxide, kaolin, alumina, talc or silicon dioxide. Suitable further pigments are available for example as Capim® MP 50 (clay), Hydragloss® 90 (Clay) or Talcum C10. Preference is given to kaolin and/or calcium carbonate (PCC and GCC).

For example, 1 to 50 parts by weight, preferably 1 to 25 parts by weight or 5 to 20 parts by weight of the binder composition of the invention are used (in solid form, i.e. without water or other solvents which are liquid at 21° C. and 1 bar) per 100 parts by weight of pigments.

Preference is given to a coating slip comprising, preferably consisting of, the polymers (i) and (ii) in a total amount of 10 to 30 parts by weight, based on 100 parts by weight of inorganic pigment (iii), and 5 to 15 parts by weight of one or more auxiliaries, the pigment of which is selected from the group consisting of calcium sulfate, calcium aluminate sulfate, barium sulfate, magnesium carbonate, calcium carbonate, silicas, aluminum oxides, aluminum hydroxide, silicates, titanium dioxide, zinc oxide, kaolin, alumina, talc and silicon dioxide, and the auxiliaries of which are selected from the group consisting of thickeners (rheology aids), co-binders, preferably polyvinyl alcohol and starch, optical brighteners, leveling agents, dispersants, surfactants, lubricants, neutralizing agents, defoamers, deaerators, preservatives and dyes.

Useful co-binders include binders having a natural basis, especially starch-based binders and lignin-based binders.

In this context, starch-based co-binders shall be understood to mean any native, modified or degraded starch. Native starches can consist of amylose, amylopectin or mixtures thereof. Modified starches can be oxidized starches, starch esters or starch ethers. The molar mass of the starch can be reduced by hydrolysis (degraded starch). Oligosaccharides or dextrins are possible degradation products. Preferred starches are cereal, corn and potato starches. Particular preference is given to cereal starch and corn starch, very particular preference is given to corn starch.

In this context, lignin-based co-binders shall be understood to mean Kraft lignin and lignosulfonate.

Polyvinyl alcohols are additionally suitable as co-binders.

The coating slip is preferably an aqueous coating slip; this comprises water particularly by virtue of the formulation form of the constituents (aqueous polymer dispersions, aqueous pigment slurries); the desired viscosity can be established via addition of further water. Customary solids contents of the coating slips are in the range from 30% to 80% by weight. Preference is given to a solids content in the range from 60% to 75% by weight. The pH of the coating slip is preferably set to values of 6 to 11, especially 7 to 10.
The present invention also relates to a method of producing the coating slip by mixing (i) the aqueous dispersion of one or more vinyl acetate polymers,
(ii) the aqueous dispersion of one or more styrene copolymers,
(iii) inorganic pigments and
(iv) optionally further auxiliaries,
(v) optionally water,

where the total amount of emulsion polymers (i) and (ii) is 10 to 30 parts by weight based on 100 parts by weight of inorganic pigment (iii) and

where the weight ratio of the styrene copolymer (ii) to the vinyl acetate polymer (i) is 77:23 to 93:7, preferably 77:23 to 90:10.

The coating slips of the invention are especially suitable for production of a coated board having a basis weight in the range from 150 to 600 g/m², preferably in the range from 200 to 350 g/m².

The invention also relates to a method of producing a coated board by
providing a multilayer board having a basis weight in the range from 150 to 600 g/m², especially 200 to 350 g/m²,
applying the coating slip of the invention to at least one surface of said board such that the coatweight of the coating slip as dry weight on a surface of the substrate is 5 to 30 g/m² and
then drying the coated board.

The board to be coated has a basis weight in the range from 150 to 600 g/m². The coating slip of the invention is especially suitable for coating of multilayer board. What is meant here by “multilayer” is that there are two, three, four or five plies of paper that have been pressed together. These underlying paper plies typically have a basis weight in the range from 20 to 200 g/m². The sum total of the paper plies give the basis weight of the uncoated board. Preference is given to multilayer board having a basis weight in the range from 200 to 350 g/m².

A commercial coated boxboard is formed, for example, from
a topcoat having a basis weight of 20 g/m²
a middle ply of bleached chemical pulp having a basis weight of 20 g/m²,
a middle ply of mechanical wood pulp having a basis weight of 140 g/m² and
a bottom ply of bleached chemical pulp having a basis weight of 20 g/m².

The amount of coating slip applied to one side of the board is generally 1 to 30 g/m², preferably 5 to 30 g (in solid form, i.e. without water or other solvents which are liquid at 21° C., 1 bar) per square meter.

The coating may be a single or double coating (primer coat and/or topcoat). The coating can be effected by means of customary application processes, for example by means of a size press, film press, blade coater, air brush, knife coater, curtain coating method or spray coater.

The present invention further provides the coated board obtainable by this method.

The coating slips of the invention have good performance properties. They have good running characteristics in paper coating processes and have a high level of binding power. The coated boards have good surface strength, especially very high dry picking resistance and low delamination. They are readily printable by the customary printing methods, such as relief printing, intaglio printing, offset printing, digital printing, flexographic printing or a combination of these printing methods.

The present invention also provides the binder composition that forms the basis of the coating slip of the invention.

### EXAMPLES

Unless the context indicates otherwise, percentages always signify weight percent.

Contents reported relate to the content in an aqueous solution or dispersion.

Where water was used in the context of the examples, demineralized water was used.

Measurement Methods

Glass transition temperature:

The glass transition temperature T_{g} of a dispersion was generally determined with the aid of a TA Instruments Q 2000 differential calorimeter. The heating rate was 10 K per minute.

Determination of the viscosity of the coating slip:

The viscosity of the dispersion was determined to ASTM D2196 with a Brookfield viscometer with RV spindle 4 at 100 rpm and at a temperature of 23° C.

Solids Content:

The solids content of a coating slip or dispersion was determined by distributing 0.5 to 1.5 g of the coating slip/dispersion in a sheet metal lid of diameter 4 cm and then drying in an air circulation drying cabinet at 140° C. for 30 minutes. The ratio of the mass of the sample after drying under the above conditions to the mass of the sample taken gives the solids content.

General Production of the Coating Slips:

The coating slip was prepared in a stirring apparatus into which the individual components were fed one after the other. The pigments were initially charged in predispersed form as a slurry. Subsequently, the rheology aid was first added, then adjusted to a pH of 9 with sodium hydroxide solution, and then the emulsion polymer was added. The final solids content was set by the addition of water.

The stated amounts are each based on solids.

| | |
|---|---|
| 100 parts by weight | of calcium carbonate (Hydrocarb 90 |
| | Slurry from OMYA, solids content |
| | 78.6% by weight) |
| 0.11 part by weight | of rheology aid (Sterocoll FS from BASF SE) |
| 16 parts by weight | of emulsion polymer from the respective |
| | example |

A 3-ply uncoated raw board having a basis weight of 225 g/m² (residual moisture content 4.5% by weight) was coated with the coating slip. The coating slip was applied to one side of the raw board using a laboratory coating machine and dried to 4.5% by weight of residual moisture by means of an IR lamp. The coating was effected by the blade coating method. One ply was applied. The coatweight was 10 g/m² (in solid form).

Determination of Delamination
Principle: The delamination characteristics of a coating slip are determined by printing a coated board sample with a pick oil test ink using an IGT AIC 2-5 printability tester. The tensile force of the pick oil test ink damages the surface to a greater or lesser degree (formation of corrugation). The lower the level of damage, the lower the level of delamination shown by the coating slip.
Preparation: 5 strips are cut out of the coated board samples to be tested in running direction of the board web in 340 mm×40 mm format.
The polyurethane rolls are inserted into the roll mill. To the left-hand roll is applied 1.3 ml (+/−0.01 ml), and to the right-hand roll 0.93 ml (+/−0.01 ml), of the chosen IGT test pick oil (Standard IGT Testing System IGT pick oil, moderate viscosity, no. 404.004.020). The comminution time is 45 minutes. Then 2 metal print wheels are inked on the left-hand roll for 90 seconds, and then on the right-hand roll for a further 90 seconds. The print speed is set to a value of 200 cm/s (standard) with rising speed; the linear pressure is 700 N(=350 N/cm).
Test: A strip of board is clipped to the circular segment, and the print operation is started.
Evaluation: The printed strip of board is then viewed under light and in a standardized manner, and the commencement of formation of corrugation on the print side is marked with a dash. The distance from the commencement of printing up to the marks is used to determine delamination. 5 strips are tested per data point.

Measurement of dry pick resistance with IGT test printer (IGT dry):

Strips of the coated board to be tested were cut and printed with the IGT test printer. The printing inks used are specific test inks from Lorilleux that transmit different tensile forces. The test strips are guided through the press with continuously rising speed (maximum speed 200 cm/s). The result is evaluated by determining the point on the printed specimen strip at which 10 pick points have occurred on the paper surface after commencement of printing. The measure of dry pick resistance mentioned is the speed in cm/s that exists at this juncture during printing, and the test ink used. The higher this print speed at the tenth pick point, the better the assessment of the quality of the paper surface.

In the examples, the following aqueous binder dispersions were used as feedstocks:
SA1: Bimodal styrene/n-butyl acrylate/acrylic acid dispersion with a solids content (SC) of 50% by weight and a glass transition temperature T_{g} of 20° C.
SA2: Monomodal styrene/n-butyl acrylate/acrylic acid dispersion with SC 50% by weight and T_{g} of 20° C.
SA3: Monomodal styrene/n-butyl acrylate/acrylic acid dispersion with SC 50% by weight and produced in the presence of 10 parts by weight of maltodextrin (dextrose equivalent DE=18, M_{w} of 11 000 and an intrinsic viscosity of ηi 0.052 dl/g) based on 100 parts by weight of monomer.

The monomer composition of the styrene/butyl acrylate/acrylic acid polymers for all three dispersions was 46/50/4.
SB1: Styrene/butadiene/acrylic acid dispersion with SC 50% by weight and T_{g} of 20° C.
SB2: Styrene/butadiene/acrylic acid dispersion with SC 50% by weight and T_{g} of 6° C., produced in the presence of 60 parts by weight of maltodextrin (DE=18, Mw of 11 000 and an intrinsic viscosity of ηi 0.052 dl/g) based on 100 parts by weight of monomer.

The monomer composition of the styrene/butadiene/acrylic acid polymers was 65/30/5 (SB1) or 57/39/4 (SB2).
D1: Vinyl acetate/ethylene copolymer dispersion (89.5/10.5 vinyl acetate/ethylene) with SC 60% by weight and T_{g} of 10° C.
D2: Vinyl acetate/ethylene copolymer (87/13 vinyl acetate/ethylene) dispersion with SC 55% by weight and T_{g} of 5° C.
D3: Vinyl acetate/ethylene copolymer dispersion (93.3/6.7 vinyl acetate/ethylene) with SC 58% by weight and Tg of 18° C.
D4: Vinyl acetate homopolymer dispersion with SC 50% by weight and T_{g} of 33° C.

Production of Coating Slips S1 to S4 (Styrene/Acrylate Polymer (SA1) and Vinyl Acetate/Ethylene Polymer (D1))

The above-detailed binder dispersions were used to produce coating slips consisting of
100 parts by weight of pigment (Omya Hydrocarb 90)
0.11 part by weight of rheology aid (Sterocoll FS)
16 parts by weight of binder (total).

All weight figures are based on the respective solids content of the components. The ratio of the two binder polymers (solid styrene-acrylate polymer/vinyl acetate/solid ethylene polymer) can be found in table 1. The solids content of the coating slip was 65% by weight; the pH was 8.8.

TABLE 1
Delamination values depending on different
compositions of SA1 and D1

| | SA1 [% by | D1 [% | Delamination | % based on |
|---|---|---|---|---|
| Ex. | wt.] | by wt.] | [cm/s] | ex. 1 |
| 1 n.i. | 100 | 0 | 116 | 0 |
| 2 | 90 | 10 | 126 | 8.6 |
| 3 | 80 | 20 | 131 | 12.9 |
| 4 n.i. | 70 | 30 | 135* | 16.4 |

n.i.: not according to the invention
*delamination of the board layers and additionally even picking of the coating were observed

It can be inferred from the examples that the binder compositions of examples 2 and 3 formulated as coating slips and applied to board lead to delamination only at relatively high tensile forces, with no observation of picking. These two coating slips are thus better than the coating slip with straight styrene-acrylate from example 1. Although example 4 shows a good denomination value, significant picking is already observed. Picking means that the slip is poor and there is poor surface cohesion.

Production of Coating Slips S5 to S9 (Styrene/Acrylate Polymer (SA2) and Various Vinyl Acetate Polymers)

The above-detailed binder dispersions were used to produce coating slips consisting of 100 parts by weight of pigment (Omya Hydrocarb 90), 0.11 part by weight of rheology aid (Sterocoll FS) and 16 parts by weight of binder (total binder in solid form). Components chosen in the binder compositions were the styrene/acrylate copolymer SA2 and various vinyl acetate/ethylene copolymers, the latter having different glass transition temperatures. The respective compositions of the two binder components can be found in table 2 (likewise based on the respective solids content).

All weight figures are based on the respective solids content of the components. The solids content of the coating slip was 65% by weight; the pH was 8.8.

TABLE 2
Delamination values depending on compositions
comprising different vinyl acetate
polymers having different glass transition temperatures

| | | 20% by | | | |
|---|---|---|---|---|---|
| | | weight of | Tg of the | | |
| | SA2 [% | vinyl acetate | vinyl acetate | Delamination | % based |
| Ex. | by wt.] | polymer | polymer [° C.] | [cm/s] | on ex. 9 |
| 5 | 80 | D1 | 10 | 111 | 12.1 |
| 6 n.i. | 80 | D2 | 5 | 106 | 7.0 |
| 7 | 80 | D3 | 18 | 123 | 24.2 |
| 8 n.i. | 80 | D4* | 33 | 97 | −2.1 |
| 9 n.i. | 100 | — | — | 99 | 0 |

*a vinyl acetate homopolymer was used in place of the vinyl acetate/ethylene polymer
n.i.: not according to the invention

It can be inferred from the examples that binder compositions comprising vinyl acetate/ethylene polymers with a T_{g} in the range from 10 to 25° C. formulated as a coating slip and applied to board lead to better delamination values of the board than a straight styrene-acrylate as binder in the coating slip.

Production of Coating Slips S10 to S15 (Styrene/Acrylate Polymers (SA1) or (SA2), Each with Vinyl Acetate/Ethylene Polymer (D3))

The above-detailed binder dispersions were used to produce coating slips consisting of

| | |
|---|---|
| 100 parts by weight | of pigment (80 parts by weight of calcium |
| | carbonate and 20 parts by weight of kaolin) |
| 0.9 part by weight | of BF-05 polyvinyl alcohol |
| 0.12 part by weight | of rheology aid (Sterocoll FS (SC: 40%)) |
| 15.5 parts by weight | of binder polymer |

The solids content of the coating slip was 65% by weight; the pH was 9. The addition was effected in this tabular sequence.

This coating slip was applied with a bent blade pilot plant (manufacturer: Voith) to singly primer-coated raw board (primer coatweight was 10 g/m² in solid form). The coatweight was 10 g/m² (in solid form). All weight figures are based on the respective solids content of the components. The ratio of the two binder polymers (solid styrene/acrylate polymer/solid vinyl acetate polymer) can be found in table 3.

TABLE 3
Delamination values depending on compositions
comprising vinyl acetate/ethylene
copolymers with different Tg

| | SA1 [% by | SA2 [% by | D3 [% | Delamination¹⁾ | IGT length |
|---|---|---|---|---|---|
| Ex. | wt] | wt.] | by wt.] | [cm/s] | (cm/s) |
| 10 n.i. | 100 | 0 | 0 | 131 | >400* |
| 11 | 90 | 0 | 10 | 292 | >400* |
| 12 | 80 | 0 | 20 | 326 | >400* |
| 13 n.i. | 0 | 100 | 0 | 103 | >400* |
| 14 | 0 | 90 | 10 | 335 | >400* |
| 15 | 0 | 80 | 20 | 372 | >400* |

n.i.: not according to the invent ion
*no picking observed
¹⁾Delamination was determined by cutting the 5 board samples in cross direction of the board web in 340 mm × 40 mm format.

Production of Coating Slips S16 to S19 (Styrene/Butadiene Polymer (SB1) or (SB2) and Vinyl Acetate/Ethylene Polymer (D3))

The above-detailed binder dispersions were used to produce coating slips consisting of
100 parts by weight of pigment (Omya Hydrocarb 90)
0.11 part by weight of rheology aid (Sterocoll FS)
16 parts by weight of binder (total).

All weight figures are based on the respective solids content of the components. The ratio of the two binder polymers (solid styrene/butadiene polymer/vinyl acetate/solid ethylene polymer) can be found in table 4. The solids content of the coating slip was 65% by weight; the pH was 8.8.

TABLE 4
Delamination values with the same monomer composition
of the styrene/butadiene/acrylic acid polymer
depending on the production thereof in the
presence of degraded starch

| | SB1 | SB2 | | | % based |
|---|---|---|---|---|---|
| | [% by | [% by | | Delamination | on ex. |
| Ex. | wt] | wt.] | D3 [% by wt.] | [cm/s] | 16 or 18 |
| 16 n.i. | 100 | 0 | 0 | 125 | 0 |
| 17 | 80 | 0 | 20 | 152 | 21.6 |
| 18 n.i. | 0 | 100 | 0 | 138 | 0 |
| 19 | 0 | 80 | 20 | 182 | 37.8 |

n.i.: not according to the invention

Production of Coating Slips S20 to S23 (Styrene/Butadiene Polymer (SA2) or (SA3) and Vinyl Acetate/Ethylene Polymer (D3))

The above-detailed binder dispersions were used to produce coating slips consisting of
100 parts by weight of pigment (Omya Hydrocarb 90)
0.11 part by weight of rheology aid (Sterocoll FS)
16 parts by weight of binder (total).

All weight figures are based on the respective solids content of the components. The ratio of the two binder polymers (solid styrene/acrylate polymer/vinyl acetate/solid ethylene polymer) can be found in table 5. The solids content of the coating slip was 66% by weight; the pH was 8.8.

TABLE 5
Delamination values with the same monomer
composition of the styrene/acrylate
polymer depending on the production
thereof in the presence of degraded starch

| | SA2 | SA3 [% by | D3 [% | Delamination | % based on ex. |
|---|---|---|---|---|---|
| Ex. | [% by wt.] | wt.] | by wt.] | (cm/s) | 20 or 22 |
| 20 n.i. | 100 | 0 | 0 | 103 | 0 |
| 21 | 80 | 0 | 20 | 126 | 22.3 |
| 22 n.i. | 0 | 100 | 0 | 105 | 0 |
| 23 | 0 | 80 | 20 | 129 | 22.8 |

n.i.: not according to the invention

### Ex. 24 and 25: Comparative Experiments with SA2 and D3

The above-detailed binder dispersions were used to produce coating slips consisting of
100 parts by weight of pigment (Omya Hydrocarb 90)
0.11 part by weight of rheology aid (Sterocoll FS)
16 parts by weight of binder (total).

TABLE 6
Delamination values for the coating
slips comprising SA2 or D3 as binder

| | SA2 | | Delamination |
|---|---|---|---|
| Ex. | [% by wt] | D3 [% by wt.] | (cm/s) |
| 24 n.i. | 100 | 0 | 103 |
| 25 n.i. | 0 | 100 | 104* |

*: The strips show additional picking

Board coated with the coating slip from example 24 or example 25 gives comparable delamination values. However, the board coated with the coating slip with D3 as binder additionally has poorer surface cohesion, since picking is also observed. The inventive mixture of the two polymers SA2 and D3 (example 21) demonstrates the existence of synergism since both an improved delamination value and good surface cohesion are observed (no picking).

1.-13. (canceled)

14. A coating slip comprising
(i) an aqueous dispersion of one or more vinyl acetate polymers, obtained by free-radically initiated emulsion polymerization of
77% to 99% by weight of vinyl acetate,
1% to 13% by weight of ethylene and
0% to 10% by weight of one or more monoethylenically unsaturated monomers that are neither vinyl acetate nor ethylene,
(ii) an aqueous dispersion of one or more styrene copolymers, obtained by free-radically initiated emulsion polymerization of a monomer composition comprising
35% to 70% by weight of styrene,
20% to 60% by weight of one or more esters of acrylic and/or methacrylic acid with alkanols having 1 to 12 carbon atoms, or of one or more conjugated aliphatic dienes,
1% to 10% by weight of one or more monomers comprising acid groups,
(iii) inorganic pigments and
(iv) optionally further auxiliaries,
where the total amount of emulsion polymers (i) and (ii) is 10 to 30 parts by weight based on 100 parts by weight of inorganic pigment (iii) and
where the weight ratio of the styrene copolymer to the vinyl acetate polymer is 77:23 to 93:7.

15. The coating slip according to claim 14, wherein the vinyl acetate polymer has a glass transition temperature T_{g} in the range from 10 to 30° C., measured to DIN EN ISO 11357-2 (2013-09).

16. The coating slip according to claim 14, wherein the one or more vinyl acetate polymer(s) is/are obtained by free-radically initiated emulsion polymerization of
82% to 98% by weight of vinyl acetate,
1% to 13% by weight of ethylene and
1% to 5% by weight of one or more monoethylenically unsaturated monomers selected from vinyl esters of α-branched monocarboxylic acids having 9 to 11 carbon atoms, vinyl laurate or vinyl esters of an α-branched carboxylic acid having 9 to 11 carbon atoms, (meth)acrylic esters of alcohols having 1 to 15 carbon atoms that also comprise 1 to 40% by weight of ethylene.

17. The coating slip according to claim 14, wherein the styrene copolymer is obtained by free-radically initiated emulsion polymerization of a monomer composition comprising
40% to 59% by weight of styrene,
40% to 59% by weight of one or more esters of acrylic and/or methacrylic acid with alkanols having 1 to 12 carbon atoms, and
1% to 10% by weight of a monomer comprising acid groups.

18. The coating slip according to claim 14, wherein the styrene copolymer is obtained by free-radically initiated emulsion polymerization in the presence of 10% to 80% by weight, based on total monomers of the styrene copolymer, of a degraded starch.

19. The coating slip according to claim 14, wherein the weight ratio of the styrene copolymer to the vinyl acetate polymer is 80:20 to 90:10.

20. The coating slip according to claim 14, wherein at least 80% by weight of the total solids content of the coating slip is inorganic pigment.

21. The coating slip according to claim 14, having a solids content of 30% to 80% by weight.

22. A process for producing the coating slip according to claim 14 by mixing
(i) the aqueous dispersion of one or more vinyl acetate polymers,
(ii) the aqueous dispersion of one or more styrene copolymers,
(iii) inorganic pigments and
(iv) optionally further auxiliaries,
(v) optionally water,
where the total amount of emulsion polymers (i) and (ii) is 10 to 30 parts by weight based on 100 parts by weight of inorganic pigment (iii) and
where the weight ratio of the styrene copolymer (ii) to the vinyl acetate polymer (i) is 77:23 to 93:7.

23. The use of the coating slip according to claim 14 for production of a coated board having a basis weight in the range from 150 to 600 g/m².

24. A method of producing a coated board by
providing a multilayer board having a basis weight in the range from 150 to 600 g/m²,
applying a coating slip according to claim 14 to at least one surface of said board such that the coatweight of the coating slip as dry weight on a surface of the substrate is 5 to 30 g/m² and
then drying the coated board.

25. The coated board obtainable by the method according to claim 24.

26. A binder composition comprising
(i) an aqueous dispersion of one or more vinyl acetate polymers, obtained by free-radically initiated emulsion polymerization of

| | |
|---|---|
| 77% to 99% by weight | of vinyl acetate, |
| 1% to 13% by weight | of ethylene and |
| 0% to 10% by weight | of one or more monoethylenically |
| | unsaturated monomers that are |
| | neither vinyl acetate nor ethylene, |

(ii) an aqueous dispersion of one or more styrene copolymers, obtained by free-radically initiated emulsion polymerization of a monomer composition comprising

| | |
|---|---|
| 35% to 70% by weight | of styrene, |
| 20% to 60% by weight | of one or more esters of acrylic |
| | and/or methacrylic acid with alkanols |
| | having 1 to 12 carbon atoms, or of one or |
| | more conjugated aliphatic dienes, |
| 1% to 10% by weight | of one or more monomers comprising |
| | acid groups. |
